(19) United States
(12) Patent Application Publication
(10) Pub. No.: US 2009/0208602 A1
(43) Pub. Date: Aug. 20, 2009

(54) CONFECTIONERY AROMA CONTAINING PRODUCTS

(76) Inventors: Jorg KOWALCZYK, Eisenberg/Steinborn (DE); Ingrid Willibald-Ettle, Landau (DE); Margit Arenz, Nehren (DE)

Correspondence Address: OSTROLENK FABER GERB & SOFFEN, 1180 AVENUE OF THE AMERICAS, NEW YORK, NY, 100368403, US

(21) Appl. No.: 12/033,451

(22) Filed: Feb. 19, 2008

(51) Int. Cl. A23G 3/54; A23G 4/00; A23G 4/18; A23L 1/48; A23G 4/06; A23G 3/36

(52) U.S. Cl. 426/5; 426/548; 426/534; 426/3; 426/103; 426/302

(57) ABSTRACT

The present invention relates to confectionery products comprising an isomalt component, a geraniol containing aroma component and at least one product additive and processes to obtain them.

### TECHNICAL FIELD

The present invention relates to confectionery products comprising an isomalt component, a geraniol containing aroma component and at least one product additive as well as processes to obtain them.

### BACKGROUND OF THE INVENTION

In consideration of the increasing demand of customers for confectionery products, which do not only appeal because of their taste but also because of the functional benefits, more and more innovative confectioneries are developed. Thus, it is desired to develop confectionery products, which do not only provide a good taste but exert furthermore an additional effect.

Recently, it has been described that distinct aromatic compounds are exhalated from human skin after intake of essential oil. The oral intake of essential oil with water resulted in an augmented release from geraniol and citronellol which were detected from hand skin using gas chromatograph mass spectrometry (Akiyama, Asaku and Itoh, Kenji, Aroma Research (2006), Vol. 7(1), 63-65). Further, the oral intake of rose oil resulted in the detection of linalool, citronellol and especially of geraniol, which are the main components of rose essential oil, from the skin (Akiyma, Asaku et al., Bunseki Kagaku (2006), 55 (10), 787-792-792).

Geraniol, also called rhodinol, is a monoterpenoid and an alcohol. It is the primary part of oil-of-rose, palmarosa oil and citronella oil. It also occurs in small quantities in geranium, lemon and many other essential oils. It appears as a clear to pale-yellow oil, which is insoluble in water, but soluble in most common organic solvents. It has a rose-like odour, for which it is commonly used in perfumes. Furthermore, research has shown geraniol to be an effective plant based insect repellent.

### SUMMARY OF THE INVENTION

The technical problem underlying the present invention is to provide confectionery products, which not only fulfil organoleptical demands of the consumer, but further harbour at least one further additional beneficial effect which increases the consumers' acceptance. In particular, it is desired to provide confectionery products which show an improved, in particular more constant and continuous release of aroma, namely geraniol and preferably are particularly storage-stable.

The present invention solves the underlying technical problem by the provision of a confectionery product, which comprises an isomalt component, a geraniol containing aroma component and at least one product additive.

Thus, the present invention solves the above-identified technical problem by providing a confectionery product comprising a mixture of an isomalt component, a geraniol containing aroma component and at least one product additive, wherein the confectionery product comprises 1.0 to 99.8 weight-% of the isomalt component, 0.1 to 5.0 weight-%, preferably 0.2 to 4.0 weight-%, most preferably 0.5 to 2.0 weight-% of the geraniol containing aroma component and 0.1 to 98.0 weight-% of at least one product additive (each based on total weight of confectionery product and all constituents adding up to 100.0% of dry matter of the confectionery product). The combination of the isomalt component with the geraniol containing aroma component surprisingly leads in confectionery products, in particular in chewing gums, coated chewing gums, soft caramels, tablets and hard caramels, to a very favourable aroma release profile, in particular a continuous, long lasting and constant release and exhalation from the skin of the consumer which in addition very rapidly starts after consumption of the product. Furthermore, it could be shown that the isomalt component increases the storage stability of the aroma component in the confectionery product.

The exhalation of geraniol leads to a pleasant rose-like odour which is released from the skin of the consumer after consumption of the confectionery product. It could surprisingly be shown that the combination of an isomalt component together with a geraniol containing aroma component advantageously leads to an even elevated, more constant and continuous exhalation of the geraniol from the skin of the consumer compared to the intake of a geraniol containing aroma component alone without the isomalt component. Without being bound to any theory, it is assumed that the elevated exhalation is a result of a more effective uptake after consumption of the geraniol due to the combination with isomalt. This in turn leads to an early beginning, elevated, prolonged and promoted release of the geraniol from the consumers' skin. Thus, the isomalt component acts as an odour release elevator. Furthermore, it has been shown that the isomalt component within the confectionery product of the present invention has the advantage to mask the unpleasant taste of the geraniol. As a further advantage it could be shown that despite its low water solubility the geraniol containing aroma component exhibits in combination with the isomalt component a homogenous distribution, especially when used in hard caramels. In chewing gums and soft candies an improved, in particular longer lasting chewability was observed.

### DETAILED DESCRIPTION OF CERTAIN EMBODIMENTS OF THE INVENTION

In the context of the present invention, the term “isomalt component” preferably encompasses isomalt, isomalt ST, isomalt GS, an isomalt variant or component thereof.

In a preferred embodiment of the present invention, the isomalt component is selected from the group consisting of 1,1-GPS (1-O-α-D-glucopyranosyl-D-sorbitol), 1,1-GPM (1-O-α-D-glucopyranosyl-D-mannitol), 1,6-GPS (6-O-α-D-glucopyranosyl-D-sorbitol), isomalt, isomalt ST and isomalt GS.

In the context of the present invention, isomalt is a mixture of 1,6-GPS and 1,1-GPM, while isomalt ST is a mixture of 53 to 47% 1,6-GPS and 47 to 53% 1,1-GPM. Isomalt GS is a mixture of 71 to 79% 1,6-GPS and 29 to 21% 1,1-GPM, preferably 75% 1,6-GPS to 25% 1,1-GPM (values given in weight-% on dry matter).

In a further preferred embodiment, it is foreseen to use isomalt variants. In the context of the present invention, isomalt variants are for instance mixtures of 10 to 50% 1,6-GPS, 2 to 20% 1,1-GPS and 30 to 70% 1,1-GPM or mixtures of 5 to 10% 1,6-GPS, 30 to 40% 1,1-GPS and 45 to 60% 1,1-GPM. Isomalt variants may also be in form of 1,6-GPS enriched mixtures. 1,6-GPS enriched mixtures have an 1,6-GPS amount of 58 to 99% and an 1,1-GPM amount of 42 to 1%. 1,1-GPM enriched mixtures have an 1,6-GPS amount of 1 to 42% and an 1,1-GPM amount of 58 to 99%.

In a further preferred embodiment of the present invention, the isomalt component used is a milled and agglomerated isomalt, in particular a milled and agglomerated isomalt, wherein the milled isomalt particles have a diameter of less than 100 μm, preferably less than 50 μm. Preferably, such a milled and agglomerated isomalt is isomalt DC.

In a preferred embodiment of the present invention, the confectionery product comprises the isomalt component in form of particles, wherein 90% of said particles have a diameter of less than 100 μm, preferably less than 50 μm.

Particle size as described herein is measured by scanning electron microscopy (SEM) or other optical or scanning techniques, for example using a coulter counter.

In a preferred embodiment of the present invention, the isomalt component is a mixture of isomalt and maltitol, preferably of isomalt GS or isomalt ST and maltitol, further preferred isomalt and maltitol syrup or of isomalt GS or isomalt ST and maltitol syrup. Preferably, the mixture comprises 60 to 80%, in particular 70% isomalt, preferably isomalt ST or GS, and 40 to 20%, in particular 30% maltitol (values given in weight-% on dry matter).

In a preferred embodiment of the present invention, the geraniol containing aroma component is a geraniol containing oil.

In a preferred embodiment of the present invention, the geraniol containing oil comprises 5 to 90, preferably 10 to 80, most preferred 10 to 20 weight-% (based on the total weight of oil) geraniol.

In a preferred embodiment of the present invention, the geraniol containing oil is an oil from geranium, lemon, coriander, bay leaves, nutmeg, tobacco and rose. In a preferred embodiment it is an oil-of-rose, palmarosa oil or citronella oil, in particular of the java type.

In a preferred embodiment of the present invention, the confectionery product is sugar-free, in particular free of sucrose, free of glucose, free of lactose and/or free of fructose or free of combinations of at least two of these sugars.

In a preferred embodiment of the present invention, the confectionery product is tooth-friendly.

In a preferred embodiment of the present invention, the confectionery product is selected from the group consisting of filled chewing gums, non-filled chewing gums, hard caramels, also called hard candies, soft caramels, also called soft candies, toffee, pastilles, tablets, gum, jellies, marshmallows, nougat, lozenges, fudge, fondant or chocolate products.

According to the invention, it could be shown that the mixture of the isomalt component and the geraniol containing aroma component provides hard candies showing a very high transparency, which are shiny and exhibit a very constant and highly efficient release of aroma. Furthermore, the hard candies of the present invention show a very homogenous distribution of the geraniol containing aroma component and improved sucking behaviour and a well-balanced aroma and sweetness impression, while simultaneously showing extraordinarily good storage stability, namely no visible crystallisation or the like.

Furthermore, coated chewing gums of the present invention also show a very good storage stability, a constant and good release of aroma, a well balanced aroma and sweetness impression and a constant and homogenous distribution of the geraniol containing aroma component.

Furthermore, the tablets or compressed products of the present invention show an improved and high storage stability, a well balanced aroma and sweetness impression as well as a homogenous and even distribution of the geraniol containing component.

Soft caramels or soft candies of the present invention show a well-balanced aroma and sweetness impression, a highly efficient constant release of aroma, a very good and even distribution of the geraniol containing component, a high storage stability and an improved prolonged chewability.

In a preferred embodiment of the present invention, the confectionery product is a coated product. Preferably, the coated product is a coated filled or non-filled chewing gum, a coated jelly, a coated tablet, a coated soft caramel or a coated chocolate product.

In a preferred embodiment of the present invention, the geraniol containing aroma component is located in the preferred coated confectionery product of the present invention solely in the coating. In another preferred embodiment of the present invention, the geraniol containing aroma component is located in the confectionery product according to the present invention solely in the centre of the confectionery product and not in the coating. In both instances, at least part of the isomalt component is associated with the geraniol containing aroma component, namely in case the geraniol containing component is located solely in the coating, at least part of the isomalt component is also contained in the coating. In another preferred embodiment, wherein the geraniol containing component is located solely in the centre of the coated confectionery product of the present invention, at least part of the isomalt component is also contained in the centre.

In another preferred embodiment of the present invention, the geraniol containing component together with the isomalt component is located both in the coating and in the centre of the preferred coated confectionery products of the present invention.

In a preferred embodiment of the present invention, the coated product comprises 15 to 70, preferably 25 to 45, weight-% product coating (based on dry weight of the overall coated product). Preferably, the coated product comprises 30 to 85, preferably 55 to 75 weight-% product core (based on the dry weight of the overall coated product).

In a particularly preferred embodiment, the product coating may comprise 1, 2 or more, for instance 50 to 100 layers of product coating material. In a particularly preferred embodiment, said layers may be of the same or different compositions.

In a further preferred embodiment, it is evident that depending upon the specific nature of the confectionery product, product additives may be present in the confectionery product or its coating.

In the context of the present invention, a product additive is any sub-stance which may be added into the preparation process to easily influence the preparation process itself and/or influence product characteristics, which may either be relevant for the process or for the finally obtained product, for instance its organoleptic, sensoric, physiological, storage or optical behaviour.

Depending upon the nature of the confectionery product, it comprises at maximum 98 weight-%, namely 0.1 to 98 weight-%, preferably 0.1 to 90 weight-%, preferably 10 to 85 weight-%, most preferably 1 to 75 weight-% of such product additives.

In a preferred embodiment of the present invention, the product additive is selected from the group consisting of sugars, preferably tooth-friendly sugars, sugar alcohols, intense sweeteners, hydrocolloid, gum base, plastifiers, lubricant, emulsifiers, protein components, milk components, dairy ingredients, fat and fat substitutes, vegetable fat, vitamins, minerals, pharmaceutically active ingredients, preservatives, further aroma, flavourings, such as peppermint, menthol, fruit, strawberry flavour, colours, TiO₂, edible acids, such as citric acid, and dietary fibres.

In a preferred embodiment of the present invention, the tooth-friendly sugar is selected from the group consisting of isomaltulose, nutriose, leukrose and polydextrose. In a preferred embodiment, the sugar is isomaltulose. In a further preferred embodiment, the amount of non-tooth-friendly ingredients is at maximum 1 weight-% (on total weight of the confectionery product).

In a further preferred embodiment of the present invention, the sugar alcohol is selected from the group of xylitol, mannitol, maltitol, erythritol, lactitol or sorbitol.

In a particularly preferred embodiment of the present invention, the isomalt component is the only sweetening agent present in the confectionery product of the present invention. In a further preferred embodiment of the present invention, the isomalt component is the only sugar alcohol present in the confectionery product of the present invention. In a further preferred embodiment, the isomalt component is the only sweetening agent providing a body to the confectionery product of the present invention. Thus, in this preferred embodiment, in addition to the isomalt component, an intense sweetener may also be present in the confectionery product.

In a preferred embodiment of the present invention, the intense sweetener is selected from the group of cyclamate, saccharin, aspartame, glycyrrhicine, neohesperidine-dihydrochalcone, steveoside, thaumatin, monellin, acesulfame, alitame, sucralose or a mixture thereof.

It is a further object of the present invention to provide a process for the preparation of a hard caramel mass comprising 1 to 99.8 weight-% of an isomalt component, 0.1 to 5.0 weight-%, preferably 0.2 to 4.0 weight-%, most preferably 0.5 to 2.0 weight-% of a geraniol containing aroma component and 0.1 to 98 weight-% of at least one product additive, wherein the process comprises a) dissolving the isomalt component in an aqueous medium, b) boiling the obtained solution to evaporate the aqueous medium, c) cooling the obtained mass, d) adding and distributing the at least one product additive to obtain a hard caramel mass, wherein the geraniol containing aroma component is added and homogenously distributed in the boiled sweetener at the end of step b) or in step c) or d). In the context of the present invention, the end of step b) is reached once substantially all of the aqueous medium has been evaporated so as to leave a highly viscous hard caramel mass. Preferably, the aqueous medium is water.

In a preferred embodiment of the present invention, the boiling in step b) is done under vacuum.

A preferred embodiment of the present invention relates to a process for the preparation of a hard caramel mass comprising 1 to 99.8 weight-% of an isomalt component, 0.1 to 5.0 weight-%, preferably 0.2 to 4.0 weight-%, most preferably 0.5 to 2.0 weight-% of a geraniol containing aroma component and 0.1 to 98 weight-% of at least one product additive, wherein the process comprises a′) melting the isomalt component, b′) cooling the obtained hard caramel mass, c′) adding and distributing the at least one product additive to obtain a hard caramel mass, wherein the geraniol containing aroma component is added and homogenously distributed in step a′) or step b′) or c′).

In a preferred embodiment of the present invention, the hard caramel mass as obtained according to the above boiling or melting process is shaped into a hard caramel.

A preferred embodiment of the present invention relates to a process for the preparation of a coated confectionery product, which comprises a product core or product centre and a product coating, the product coating comprising at least the coating ingredients at least an isomalt component, a geraniol containing aroma component and at least one product additive, preferably according to the above, which process comprises a) applying a coating medium comprising at least partially the coating ingredients to said product core and b) drying the coated product so as to obtain a product coating, which coating comprises 1 to 99.8 weight-% isomalt component, 0.1 to 5.0 weight-%, preferably 0.2 to 4.0 weight-%, most preferably 0.5 to 2.0 weight-% of a geraniol containing aroma component and 0.1 to 98 weight-% (each based on dry weight of product coating) of at least one product additive. If in one preferred embodiment only a part of the coating ingredients is added into the coating medium, then the other part is applied in a dusting or drying step thereafter.

In the context of the present invention, drying of the coated core with a dry and powdered ingredient is also called dusting.

Preferably, the coating medium is an aqueous medium, particularly water.

In a preferred embodiment of the present invention, the drying of step b) is done by subjecting the coated product to air, in particular an air stream, having a temperature of 20° C. to 80° C., preferably 30° C. to 80° C.

In a preferred embodiment of the present invention, the drying step b) is done by adding at least a part of the coating ingredients in dry and powdered form to the coated products during step b).

In a preferred embodiment of the present invention, the coating medium is a coating solution or coating suspension.

In a preferred embodiment of the present invention, after step a) and before step b) the coated products are subjected to a distribution step, wherein the coated products are agitated to allow a homogenous distribution of the coating medium on the product core.

In a preferred embodiment of the present invention, in step a) all coating ingredients are applied in form of a coating medium, in particular a coating suspension.

In a preferred embodiment of the present invention, a part of the coating ingredients is applied in the coating medium and a further part is applied in dry and powdered from, both of them in step a).

In a further preferred embodiment of the present invention, all of the geraniol containing aroma component of the product coating is added in step b).

In a preferred embodiment of the present invention, all of the geraniol containing aroma components of the product coating is added in form of the oil and part of the isomalt component is added in dry and powdered form, both of them in step b).

In a further preferred embodiment of the present invention, at least a part if the isomalt component is added in dry and powdered from in step b).

In a preferred embodiment of the present invention, steps a) and b) are repeated one or more times, preferably 8 to 120 times.

In a preferred embodiment of the present invention, steps a) and b) are repeated 3 to 10 times.

In a preferred embodiment of the present invention, the coating ingredients applied in powder form represent 30 to 75% by weight, preferably 40 to 75% by weight of the overall amount of the coating ingredients (each based on dry weight of the product coating).

In a preferred embodiment of the present invention, the process of the present invention is carried out in at least two phases, wherein in a first phase of the process, the coating medium comprising a part of the coating ingredient is applied in step a) and the drying is done in step b) by adding part of the coating ingredients in dry and powdered form to the coated products one or more repeated times and wherein in a second phase of the process the coating medium is applied to the coated products in step a) and dried in step b) by subjecting the coated products to air without addition of dry and powdered coating ingredients one or more repeated times.

In a preferred embodiment of the present invention, the drying of step b) is done both by subjecting the coated products to air having a temperature of 20 to 80° C. and by adding part of the coating ingredients in dry and powdered form to the coated products during step b).

In a preferred embodiment of the present invention, steps a) and b) are repeated 3 to 50 times.

In a preferred embodiment of the present invention, in a first phase of the repetitions of steps a) and b) the drying of step b) is done by adding part of the coating ingredients in dry and powdered form to the coated products and wherein in a second phase of the repetitions only the coating medium is applied and the drying of step b) is done by subjecting the coated product to air having a temperature of 20 to 80° C.

Further preferred embodiments of the present invention are the subject-matter of the subclaims.

### EXAMPLES

The invention is illustrated by way of the following examples. These examples are provided only for the purpose of illustrating the invention and are not, in any way, to be construed as limiting the invention.

### Example 1

### Tablets

### Recipe:

| | | |
|---|---|---|
| isomalt DC 100 | 9.9 | kg |
| geraniol oil | 50 | g |
| acesulfam K | 15 | g |
| citric acid | 30 | g |
| aroma (strawberry) | 50 | g |
| magnesium stereat | 50 | g |

### Preparation:

The components were mixed and compressed in a rotary press.

| | |
|---|---|
| Tablet diameter: | 12 mm |
| Tablet weight | app. 600 mg |
| pressure force | 8-15 kN |
| hardness | 180-220 N |

Very storage-stable tablets were obtained with favourable organoleptic and sensoric properties, which provide a pleasant and long-lasting, continuously released rose-like odour by exhalation from the skin.

### Example 2

### Preparation of a Hard Caramel

### Recipe:

| | | |
|---|---|---|
| isomalt ST | 23.0 | kg |
| geraniol oil | 50 | g |
| water | 8.5 | kg |
| menthol | 0.1 | kg |
| peppermint | 0.2 | kg |
| acesulfam K | 25 | g |

### Preparation:

Isomalt ST and water are mixed in a pan followed by heating to dissolve the isomalt and boiling this mixture at a temperature from 155 to 160° C. A 5 minute vacuum was applied so as to obtain a highly viscous caramel mass and after cooling of the mass to 110° C. to 115° C. the citric acid, the aroma, acesulfam K and the geraniol oil are added and are homogenously distributed. The so prepared hard caramel mass was moulded to form hard candies.

The above-identified recipe without water has also been processed directly to a hard caramel in a melt extrusion process by simultaneously extruding the ingredients and forming hard caramels therefrom.

In a continuously operating process, the geraniol oil has been added after boiling of the isomalt ST solution into the highly viscous, but still liquid hard caramel mass, which thereafter is transferred on a cooling belt and further processed by moulding and cooling in order to obtain the final hard caramels.

Hard caramels were obtained with favourable organoleptic, a high transparency and improved sensoric properties, which provide a pleasant long-lasting and continuously released rose-like odour by exhalation from the skin. The hard caramels shown an excellent storage stability.

### Example 3

### Chewing Gum

### Recipe:

| | | |
|---|---|---|
| chewing base Nostic TWA | 1400 | g |
| isomalt ST | 2200 | g |
| sorbitol syrup (70% dry substance) | 600 | g |
| geraniol oil | 40 | g |
| glycerol | 150 | g |
| menthol | 150 | g |
| flavour (spearmint) | 100 | g |
| aspartam | 2.5 | g |
| acesulfam K | 2.5 | g |

### Preparation:

The chewing gum base is heated at approximately 55° C. in a heating oven, before it is placed in a kneader; subsequently, the chewing gum base is kneaded for 1-2 minutes. During the kneading, the powdery additives (isomalt ST (1:1 mixture of 1,6-GPS and 1,1-GPM), geraniol oil, sweetener, menthol) are gradually added in the indicated sequence; afterwards, flavour, sorbitol syrup and glycerol are added. The kneading continues until the mass is homogenous (end temperature approximately 45° C.). The mass is taken from the kneader and divided into portions which weigh approximately 1 kg.

The chewing gum mass divided into portions is placed in intermediate storage for approximately 15 to 20 min on a talc-strewn substrate, extruded with a suitable extruder, and further processed as usual.

Very storage-stable chewing gums were obtained with prolonged chewability, favourable organoleptic and sensoric properties, which provide a pleasant, long-lasting and continuously released rose-like odour by exhalation from the skin.

### Example 4

### Preparation of a Coated Chewing Gum

### A) Composition of the Coated Chewing Gum:

### Center:

TABLE 1

| | Amount [% based on |
|---|---|
| Ingredient | weight of center] |
| Glycerol | 1.78 |
| Water | 1.30 |
| Xylitol | 7.81 |
| Mannitol | 7.92 |
| Maltitol | 0.63 |
| Sorbitol | 44.40 |
| 1,1-Glucopyranosyl-mannitol (1,1- | 0.02 |
| GPM) | |
| 1,6-Glucopyranosyl-sorbitol (1,6- | 0.06 |
| GPS) | |
| Gum base | 36.08 |

### Coating:

TABLE 2

| | Amount [% based on dry |
|---|---|
| Ingredient | weight of coating] |
| Isomalt GS (75 weight-% 1,6-GPS, | 94.00 |
| 25 weight-% 1,1-GPM) | |
| Gum arabic | 2.00 |
| geraniol oil | 4.00 |

B) Coating with Geraniol Oil

A coating solution comprising as coating ingredients 5500 g isomalt GS, 410 g of a 50% gum arabic solution (205 g gum arabic, dry matter) and 3980 g water was prepared. Chewing gum cushions with a weight of 1,018 g/pc are provided. In a coating drum, the coating solution is applied to the chewing gum cushions at 60° C., wherein during said coating a mixture of isomalt GS/PA (powder, 90% of the particles <50 μm) and 0.1% SiO₂ is sequentially added as powdery dry charges in a first phase of 2×160 g, in a second phase of 7×150 g and in a third phase of 4×170 g. The applied coating layers are dried after each cycle with a constant air stream with a temperature ranging from 23 to 28° C. Afterwards, the geraniol oil is added to the coating solution and the coating solution is applied in a fourth phase in 5 cycles, in a fifth phase in 5 cycles and in a sixth phase in 3 cycles. The applied coating layers are dried after each cycle with a constant air stream. Thus, in overall, a coated product is prepared comprising 33 weight-% coating and about 67 weight-% (each based on dry weight of final product) chewing gum centre.

A coated chewing gum was obtained with favourable organoleptic and sensoric properties, which provides a constant and continuously released pleasant rose-like odour by exhalation from the skin. The coating showed a very good storage stability.

What is claimed is:

1. A confectionery product comprising an isomalt component, a geraniol containing aroma component and at least one product additive, wherein the confectionery product comprises 1 to 99.8 weight-% of the isomalt component, 0.1 to 5.0 weight-% of the geraniol containing aroma component and 0.1 to 98 weight-% of the at least one product additive, each based on total weight of confectionery product and all constituents adding up to 100% of the dry matter of the confectionery product.

2. The confectionery product according to claim 1, wherein the isomalt component is selected from the group consisting of 1,1-GPS (1-O-α-D-glucopyranosyl-D-sorbitol), 1,1-GPM (1-O-α-D-glucopyranosyl-D-mannitol), 1,6-GPS (6-O-α-D-glucopyranosyl-D-sorbitol), isomalt variants, isomalt and isomalt GS.

3. The confectionery product according to claim 1, wherein the isomalt component is a mixture of isomalt and maltitol, a mixture of isomalt GS or ST and maltitol, a mixture of isomalt and maltitol syrup or a mixture of isomalt GS or ST and maltitol syrup.

4. The confectionery product according to claim 3, wherein the mixture of isomalt and maltitol comprises 60 to 80 weight-% isomalt and 40 to 20 weight-% maltitol, and wherein the weight-% is based on the weight of dry matter.

5. The confectionery product according to claim 1, wherein the geraniol containing aroma component is a geraniol containing oil.

6. The confectionery product according to claim 5, wherein the oil comprises 5 to 90 weight-%, based on total weight of oil, geraniol.

7. The confectionery product according to claim 1, wherein the confectionery product is sugar-free.

8. The confectionery product according to claim 1, wherein the confectionery product is tooth-friendly.

9. The confectionery product according to claim 1, wherein the confectionary product is selected from the group consisting of chewing gums, hard caramels, soft caramels, toffee, pastille, tablets, gum, jellies, marshmallows, nougat, lozenges, fudge, fondant and chocolate products.

10. The confectionery product according to claim 1, wherein the confectionery product is a coated product.

11. The confectionery product according to claim 10, wherein the coated product is a coated chewing gum, a coated jelly, a coated tablet, a coated soft-caramel or a coated chocolate product.

12. The confectionery product according to claim 1, wherein the product additive is selected from the group consisting of sugars, sugar alcohols, intense sweeteners, hydrocolloid, gum base, plastifiers, emulsifyers, protein components, milk components, dairy ingredients, fat and fat substitutes, vegetable fat, vitamins, minerals, pharmaceutically active ingredients, preservatives, aroma, flavourings, colours, TiO₂, edible acids and dietary fibres.

13. The confectionery product according to claim 12, wherein the sugar is selected from the group consisting of isomaltulose, nutriose, leucrose and polydextrose.

14. The confectionery product according to claim 12, wherein the sugar alcohol is xylitol, mannitol, maltitol, erythritol, lactitol or sorbitol.

15. The confectionery product according to claim 12, wherein the intense sweetener is selected from the group of cyclamate, saccharin, aspartame, glycyrrhicine, neohesperidine-dihydrochalcone, steveoside, thaumatin, monellin, acesulfame, alitame, sucralose or a mixture thereof.

16. A process for the preparation of a hard caramel mass comprising 1 to 99.8 weight-% of an isomalt component, 0.1 to 5.0 weight-% of a geraniol containing aroma component and 0.1 to 98 weight-% of at least one product additive, wherein the process comprises a) dissolving the isomalt component in an aqueous medium, b) boiling the obtained solution to evaporate the aqueous medium, c) cooling the obtained mass, d) adding and distributing the at least one product additive to obtain a hard caramel mass, wherein the geraniol containing aroma component is added and homogenously distributed in the boiled sweetener at the end of step b) or in step c) or d).

17. The process for the preparation of a hard caramel mass according to claim 16, wherein the boiling in step b) is done under vacuum.

18. A process for the preparation of a hard caramel mass comprising 1 to 99.8 weight-% of an isomalt component, 0.1 to 5.0 weight-% of a geraniol containing aroma component and 0.1 to 98 weight-% of at least one product additive, wherein the process comprises a′) melting the isomalt component, b′) cooling the obtained hard caramel mass, c′) adding and distributing the at least one product additive to obtain a hard caramel mass, wherein the geraniol containing aroma component is added and homogenously distributed in step a′), b′) or c′).

19. A process for the preparation of a hard caramel mass according to claim 16, wherein the hard caramel mass is shaped to a hard caramel.

20. A process for the preparation of a hard caramel mass according to claim 18, wherein the hard caramel mass is shaped to a hard caramel.

21. A process for the preparation of a coated confectionery product comprising a product core and a product coating, the coating comprising at least the coating ingredients at least an isomalt component, a geraniol containing aroma component and at least one product additive, which process comprises a) applying a coating medium comprising at least some of the coating ingredients to said product core, and b) drying the coated product, so as to obtain a product coating, which coating comprises 1 to 99.8 weight-% isomalt component, 0.1 to 5.0 weight-% geraniol containing aroma component and 0.1 to 98 weight-%, each based on dry weight of product coating, of at least one product additive.

22. The process for the preparation of a coated confectionery product according to claim 21, wherein the drying of step b) is done by subjecting the coated product to air.

23. The process for the preparation of a coated confectionery product according to claim 22, wherein the drying of step b) is done by subjecting the coated product to an air stream having a temperature of 20° C. to 80° C.

24. The process for the preparation of a coated confectionery product according to claim 21, wherein the drying of step b) is done by adding at least a part of the coating ingredients in dry and powdered form to the coated products during step b).

25. The process for the preparation of a coated confectionery product according to claim 21, wherein the coating medium is a coating solution or coating suspension.

26. The process for the preparation of a coated confectionery product according to claim 21, wherein after step a) and before step b) the coated products are further subjected to a distribution step, wherein the coated products are agitated to allow a homogenous distribution of the coating medium on the product core.

27. The process for the preparation of a coated confectionery product according to claim 21, wherein in step a) all coating ingredients are applied in form of a coating medium.

28. The process for the preparation of a coated confectionery product according to claim 27, wherein the coating medium is a coating suspension.

29. The process for the preparation of a coated confectionery product according to claim 21, wherein a part of the coating ingredients is applied in the coating medium and a further part is applied in dry and powdered form, both of them in step a).
